(19) United States
(12) Patent Application Publication
(10) Pub. No.: US 2018/0089106 A1
(43) Pub. Date: Mar. 29, 2018

(54) METHOD AND APPARATUS FOR REPLACING DATA BLOCK IN CACHE

(71) Applicant: Huawei Technologies Co., Ltd., Shenzhen (CN)

(72) Inventor: Hengchao XIN, Shenzhen (CN)

(21) Appl. No.: 15/828,712

(22) Filed: Dec. 1, 2017

Related U.S. Application Data
(63) Continuation of application No. PCT/CN2016/084580, filed on Jun. 2, 2016.

(30) Foreign Application Priority Data
Jun. 3, 2015 (CN) 201510299437.4

(51) Int. Cl. G06F 12/121; G06F 12/0864; G06F 12/0811

(52) U.S. Cl. CPC G06F 12/121; G06F 12/0811; G06F 12/0864

(57) ABSTRACT

The invention discloses a method for replacing a data block in a cache, including: selecting, at a specified interval, an available way from available ways of a first mode as a used-for-replacement way of the first mode, where each available way of the first mode has an equal probability of acting as the used-for-replacement way of the first mode, the first mode is one of multiple modes, and the available ways of the first mode are ways allocated to the first mode; receiving a first data access request, where the first data access request includes an identifier of the first mode; and storing a data block, to be accessed by using the first data access request, in the used-for-replacement way of the first mode when the data block to be accessed by using the first data access request is not stored in the cache.

### CROSS-REFERENCE TO RELATED APPLICATIONS

This application is a continuation of International Application No. PCT/CN2016/084580, filed on Jun. 2, 2016, which claims priority to Chinese Patent Application No. 201510299437.4, filed on Jun. 3, 2015, both of which are hereby incorporated by reference in their entireties.

### TECHNICAL FIELD

The present invention relates to the field of storage technologies, and in particular, to a method and an apparatus for replacing a data block in a cache.

### BACKGROUND

A cache (Cache) is a memory located between a main memory and a central processing unit (CPU for short). Storage space of the cache is divided into several sets. Each set includes several ways, and each set includes an equal quantity of ways. A way is a minimum unit of data storage in the cache. Storage space of the main memory is divided into several areas relative to sets. Each area includes several blocks, and a quantity of blocks included in each area is equal to a quantity of sets in the cache. An address mapping exists between the blocks included in each area and the sets. Data stored in a block in each area can be stored in any way included in a set having an address mapping with the block.

Currently, the cache can support multimode separation. Multimode separation means that data of multiple modes (network standards or virtual machines (VM for short)) can be stored in one cache. Because ways allocated to each mode are generally not all ways in a cache, a data block in the main memory is usually stored in the following manner into a way allocated to a mode: first, determining, according to a block that stores the data block and that is in the main memory, a set that is in the cache and has an address mapping with the block as a set for storing the data block; randomly selecting one way from all ways in the determined set if all the ways store data; determining, among ways allocated to the mode, a way closest to the selected way as a way for storing the data block; and replacing data originally stored in the determined way with the data block.

In a process of implementing the present invention, the inventor finds that the prior art has at least the following problems:

If the ways allocated to the mode are not evenly distributed in all the ways, probabilities of data block replacement by using the ways allocated to the mode are unequal, affecting system performance. However, it is relatively difficult to evenly distribute, in all the ways, ways allocated to each mode.

### SUMMARY

To resolve a problem in the prior art that probabilities of data replacement by using various ways are unequal, embodiments of the present invention provide a method and an apparatus for replacing a data block in a cache. The technical solutions are as follows:

According to an aspect, an embodiment of the present invention provides a method for replacing a data block in a cache, where the cache includes several ways, the several ways are allocated to multiple modes, and the modes are network standards or virtual machines VMs; and the replacement method includes:

selecting, at a specified interval, an available way from available ways of a first mode as a used-for-replacement way of the first mode, where each available way of the first mode has an equal probability of acting as the used-for-replacement way of the first mode, the first mode is one of the multiple modes, and the available ways of the first mode are ways allocated to the first mode;

receiving a first data access request, where the first data access request includes an identifier of the first mode; and

storing a data block, to be accessed by using the first data access request, in the used-for-replacement way of the first mode when the data block to be accessed by using the first data access request is not stored in the cache.

In a possible implementation manner of this embodiment of the present invention, the available way selected at the specified interval changes periodically or randomly.

In another possible implementation manner of this embodiment of the present invention, the selecting, at a specified interval, an available way from available ways of a first mode as a used-for-replacement way of the first mode includes:

determining the used-for-replacement way of the first mode by using a masked replace way generator MRWG, where input to the MRWG is a mask that indicates the available ways of the first mode, and output from the MRWG is an indication signal that indicates the used-for-replacement way of the first mode.

Optionally, the storing a data block, to be accessed by using the first data access request, in the used-for-replacement way of the first mode when the data block to be accessed by using the first data access request is not stored in the cache includes:

selecting, according to a correspondence between an identifier of a first mode and an identifier of an MRWG, an MRWG corresponding to the first mode;

determining a way indicated by output from the selected MRWG as the used-for-replacement way of the first mode; and

storing the data block, to be accessed by using the first data access request, in the used-for-replacement way of the first mode.

In still another possible implementation manner of this embodiment of the present invention, the replacement method further includes:

selecting an available way from available ways of a second mode as a used-for-replacement way of the second mode when an available way is selected from the available ways of the first mode as the used-for-replacement way of the first mode, where each available way of the second mode has an equal probability of acting as the used-for-replacement way of the second mode, the second mode is one of the multiple modes, and the available ways of the second mode are ways allocated to the second mode.

In yet another possible implementation manner of this embodiment of the present invention, the replacement method further includes:

receiving a second data access request, where the second data access request includes an identifier of a third mode, and the third mode is one of the multiple modes;

selecting, according to a preset rule, a way from specified ways as a used-for-replacement way of the third mode when a data block to be accessed by using the second data access request is not stored in the cache; and

storing the data block, to be accessed by using the second data access request, in the used-for-replacement way of the third mode.

According to another aspect, an embodiment of the present invention provides an apparatus for replacing a data block in a cache, where the cache includes several ways, the several ways are allocated to multiple modes, and the modes are network standards or virtual machines VMs; and the replacement apparatus includes:

a first determining module, configured to select, at a specified interval, an available way from available ways of a first mode as a used-for-replacement way of the first mode, where each available way of the first mode has an equal probability of acting as the used-for-replacement way of the first mode, the first mode is one of the multiple modes, and the available ways of the first mode are ways allocated to the first mode;

a first receiving module, configured to receive a first data access request, where the first data access request includes an identifier of the first mode; and

a first storage module, configured to store a data block, to be accessed by using the first data access request, in the used-for-replacement way of the first mode when the data block to be accessed by using the first data access request is not stored in the cache.

In a possible implementation manner of this embodiment of the present invention, the available way selected at the specified interval changes periodically or randomly.

In another possible implementation manner of this embodiment of the present invention, the first determining module is configured to:

determine the used-for-replacement way of the first mode by using a masked replace way generator MRWG, where input to the MRWG is a mask that indicates the available ways of the first mode, and output from the MRWG is an indication signal that indicates the used-for-replacement way of the first mode.

Optionally, the first storage module includes:

a selection unit, configured to select, according to a correspondence between an identifier of a first mode and an identifier of an MRWG, an MRWG corresponding to the first mode;

a determining unit, configured to determine a way indicated by output from the selected MRWG as the used-for-replacement way of the first mode; and

a storage unit, configured to store the data block, to be accessed by using the first data access request, in the used-for-replacement way of the first mode.

In still another possible implementation manner of this embodiment of the present invention, the replacement apparatus further includes:

a second determining module, configured to select an available way from available ways of a second mode as a used-for-replacement way of the second mode when an available way is selected from the available ways of the first mode as the used-for-replacement way of the first mode, where each available way of the second mode has an equal probability of acting as the used-for-replacement way of the second mode, the second mode is one of the multiple modes, and the available ways of the second mode are ways allocated to the second mode.

In yet another possible implementation manner of this embodiment of the present invention, the replacement apparatus further includes:

a second receiving module, configured to receive a second data access request, where the second data access request includes an identifier of a third mode, and the third mode is one of the multiple modes;

a selection module, configured to select, according to a preset rule, a way from specified ways as a used-for-replacement way of the third mode when a data block to be accessed by using the second data access request is not stored in the cache; and

a second storage module, configured to store the data block, to be accessed by using the second data access request, in the used-for-replacement way of the third mode.

The technical solutions provided by the embodiments of the present invention bring about the following beneficial effects:

An available way is selected at a specified interval from available ways of a first mode as a used-for-replacement way of the first mode, and each available way of the first mode has an equal probability of acting as the used-for-replacement way of the first mode. That is, the used-for-replacement way of the first mode may be any available way of the first mode. A data block to be accessed by using a first data access request is stored in the used-for-replacement way of the first mode when the data block to be accessed by using the first data access request is not stored in a cache. Therefore, each available way of the first mode has an equal probability of storing the data block to be accessed by using the first data access request. That is, each available way of the first mode has an equal probability of being used for implementing replacement of a data block of the first mode.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a diagram of an application scenario of a method for replacing a data block in a cache according to an embodiment of the present invention;

FIG. 2 is a schematic diagram of a relationship between a CPU request and a cache structure according to an embodiment of the present invention;

FIG. 3 is a schematic diagram of a relationship between a main memory structure and a cache structure according to an embodiment of the present invention;

FIG. 4 is a flowchart of a method for replacing a data block in a cache according to Embodiment 1 of the present invention;

FIG. 5 is a flowchart of a method for replacing a data block in a cache according to Embodiment 2 of the present invention;

FIG. 6 is a schematic diagram of hardware implementation of selecting a used-for-replacement way of a first mode according to Embodiment 2 of the present invention;

FIG. 7 is a schematic structural diagram of an apparatus for replacing a data block in a cache according to Embodiment 3 of the present invention;

FIG. 8 is a schematic structural diagram of an apparatus for replacing a data block in a cache according to Embodiment 4 of the present invention; and

FIG. 9 is a structural diagram of hardware of an apparatus for replacing a data block in a cache according to Embodiment 5 of the present invention.

### DESCRIPTION OF EMBODIMENTS

To make the objectives, technical solutions, and advantages of the present invention clearer, the following further describes the embodiments of the present invention in detail with reference to the accompanying drawings.

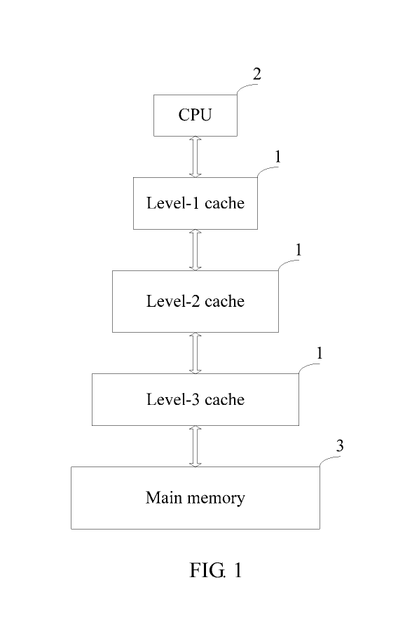

First, with reference to FIG. 1, the following briefly describes an application scenario of a method for replacing a data block in a cache provided by the embodiments of the present invention. As shown in FIG. 1, one or more caches 1 are disposed between a CPU 2 and a main memory 3. When there are multiple caches 1, the caches 1 are disposed in sequence between the CPU 2 and the main memory 3, and are referred to as a level-1 cache, a level-2 cache, and so on. In a direction from the CPU 2 to the main memory 3, access speeds of the caches 1 decrease, and capacities of the caches 1 increase. For example, among the caches 1, the level-1 cache closest to the CPU 2 has a highest access speed and a smallest capacity, and the last cache 1 (a level-3 cache shown in FIG. 1) closest to the main memory 3 (that is, furthest from the CPU 2) has a lowest access speed and a largest capacity.

Each cache 1 can store a data block that is in the main memory 3. When the CPU 2 is to access a data block in the main memory 3, the CPU 2 first sends a request to the level-1 cache rather than sends the request directly to the main memory 3. If the level-1 cache stores the data block, the level-1 cache performs a read operation or a write operation on the data block according to the request (the CPU 2 completes access to the data block). If the level-1 cache does not store the data block, the level-1 cache forwards the request to the level-2 cache, and stores the data block after the CPU 2 completes access to the data block. If the level-2 cache receives the request, the level-2 cache determines whether the level-2 cache stores the data block. If the level-2 cache stores the data block, the level-2 cache performs a read operation or a write operation on the data block according to the request. If the level-2 cache does not store the data block, the level-2 cache forwards the request to the level-3 cache, and stores the data block after the CPU 2 completes access to the data block. The rest may be deduced by analogy. If the main memory 3 receives the request, the main memory 3 performs a read operation or a write operation on the data block according to the request.

It is easily known that a processing speed of the CPU 2 is far higher than an access speed of the main memory 3, and a speed mismatch between the CPU 2 and the main memory 3 seriously limits overall performance of a computer. Compared with the main memory 3, the caches 1 have small capacities but high speeds (especially, a speed of the level-1 cache is generally close to a speed of a CPU). Disposing the caches 1 between the CPU 2 and the main memory 3 can reduce a delay in accessing the main memory by the CPU, and effectively reduce a speed difference between the CPU 2 and the main memory 3, thereby improving overall performance of the computer.

It should be noted that the method for replacing a data block in a cache provided by the embodiments of the present invention is applicable to any one of the foregoing caches 1 (for example, the level-1 cache). This is not limited in the present invention.

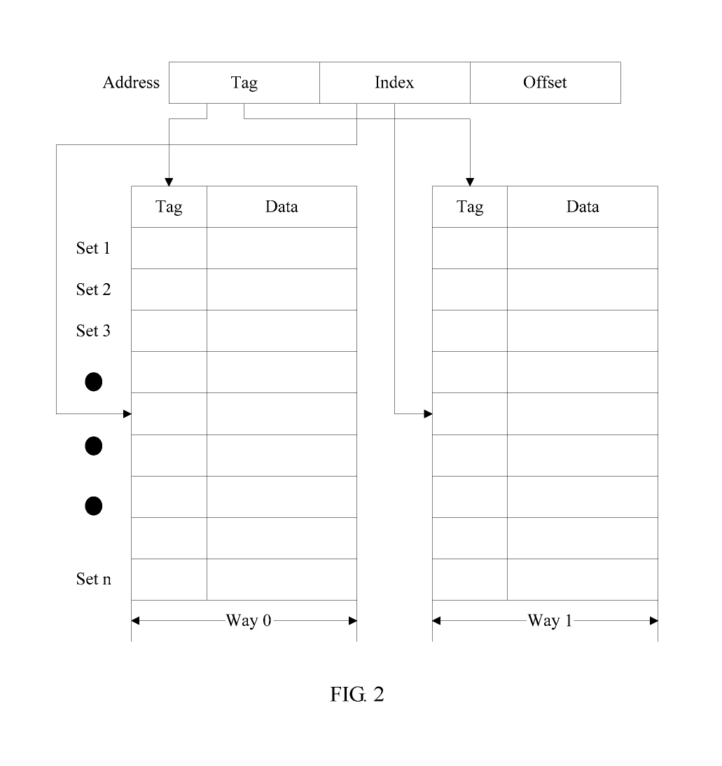

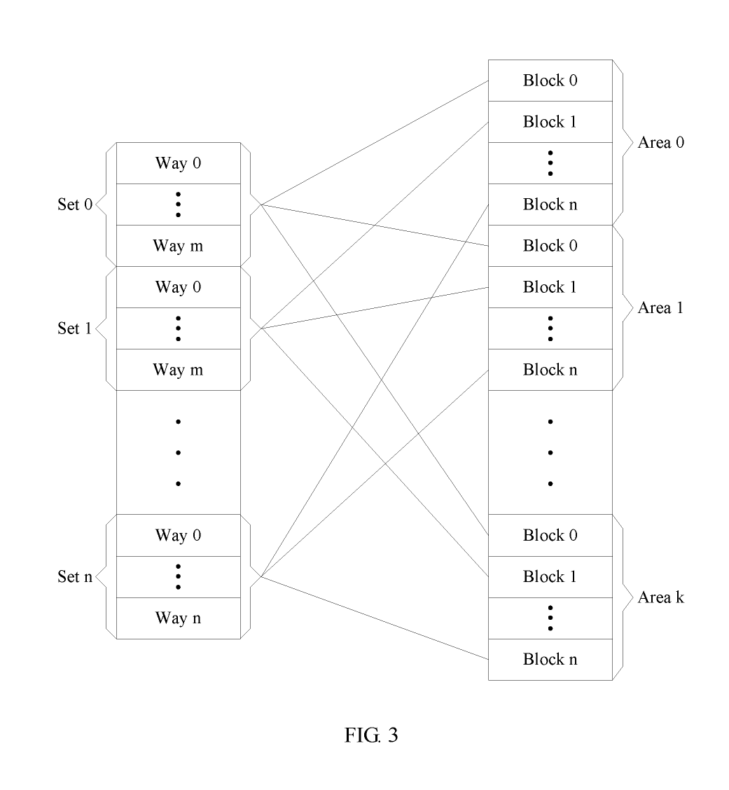

For a cache, as shown in FIG. 2, internal storage space is divided into several sets. Each set includes several ways, and each set includes an equal quantity of ways. A way is a minimum unit of data storage in the cache. Space of a main memory is divided into several areas (or pages) relative to sets. As shown in FIG. 3, each area includes several blocks, and a quantity of blocks included in each area is equal to a quantity of sets in the cache. An address mapping exists between the blocks included in each area and the sets. Data stored in a block in each area can be stored in any way included in a set having an address mapping with the block. Specifically, referring to FIG. 2, each way includes a tag (tag) field and a data (data) field. The data field is used to store a data block. The tag field is used to store a high-order address such as an area number (or a page number), in the main memory, of the data block stored in the data field.

According to a quantity of sets and a quantity of ways, cache structures are classified into three types: direct-mapped structure, fully associative structure, and set associative structure. In a direct-mapped cache, each set includes only one way. A fully associative cache includes only one set. In a set associative cache, a quantity of sets and a quantity of ways are both greater than 1.

Also as shown in FIG. 2, an address (address) part in a data access request of a CPU includes a tag (tag) field, an index (index) field, and an offset (offset) field. The index field includes a low-order address such as a block number, in the main memory, of a to-be-accessed data block. Because there is an address mapping between a block in the main memory and a set in the cache, the index field can be used to index a set. The tag field includes a high-order address such as an area number (or a page number), in the main memory, of a data block. Because a tag field of each way in the cache stores a high-order address, in the main memory, of a data block stored in the way, the tag field in the request can be used for a comparison with the tag field of the way in the cache, so as to determine whether the data block stored in the way is the to-be-accessed data block. The offset field indicates an address, in the data block, of to-be-accessed data.

After the cache receives the data access request of the CPU, the cache first determines, according to the index field in the address part of the request, a set to which the to-be-accessed data block belongs. Then, the cache compares the tag field in the address part of the request with a tag of each way in the determined set. If the tag field in the address part of the request is the same as a tag field of a way, it indicates that the to-be-accessed data block is stored in the cache, and this situation is referred to as a hit. If the tag field in the address part of the request is different from tag fields of all ways in the set, it indicates that the to-be-accessed data block is not stored in the cache, and this situation is referred to as a miss. Upon a miss, the cache first forwards the request to another memory, and then writes, after the CPU completes access to the data block, the accessed data block (that is, a data block in the main memory) into a way in the previously determined set, so as to store the data block (if the way into which the data block is to be written stores data originally, a writing process is a data block replacement process). If the determined set includes multiple ways, first, a way needs to be selected from the multiple ways included in the determined set, and then the accessed data block is stored in the selected way.

In a direct-mapped cache, each set includes only one way, and way selection does not need to be performed. Therefore, the method for replacing a data block in a cache provided by the embodiments of the present invention mainly applies to a fully associative cache and a set associative cache, especially to a set associative cache.

### Embodiment 1

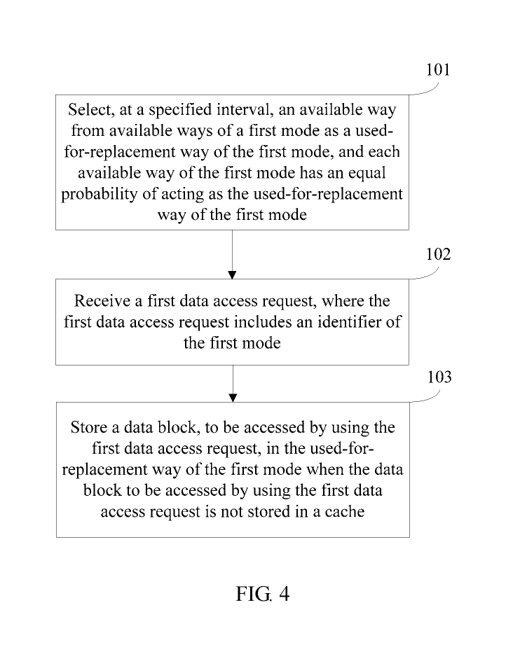

This embodiment of the present invention provides a method for replacing a data block in a cache. Storage space of the cache is divided into several sets. Each set includes several ways, and each set includes an equal quantity of ways. The storage space of the cache is divided and allocated to multiple modes according to ways. All the modes can use same several ways in all the sets, that is, the several ways are allocated to the multiple modes. The modes are network standards or VMs. Referring to FIG. 4, the replacement method includes the following steps.

Step 101: Select, at a specified interval, an available way from available ways of a first mode as a used-for-replacement way of the first mode, and each available way of the first mode has an equal probability of acting as the used-for-replacement way of the first mode. Step 101 may be performed all the time.

In this embodiment, the first mode is one of the multiple modes and may be a network standard or a VM. It should be noted that there may be one or more first modes in the multiple modes to which ways in the cache are allocated. Specifically, network standards include Global System for Mobile Communications (GSM for short), Code Division Multiple Access (CDMA for short), 3rd Generation mobile telecommunications technology (3G for short), Long Term Evolution (LTE for short), and the like. The VM is a computer system that runs in a completely isolated environment, that has complete hardware system functions, and that is simulated by using software on an operating system of a computer.

The available ways of the first mode are ways allocated to the first mode. For example, all ways in the cache are ways 0 to 15. Ways allocated to a network standard 1 (for example, GSM) are the ways 0 to 7, and ways allocated to a network standard 2 (for example, CDMA) are the ways 8 to 15. If the first mode is the network standard 2, the available ways of the first mode are the ways 8 to 15. Alternatively, ways allocated to a VM 1 are the way 0, the way 4, the way 8, and the way 12; ways allocated to a VM 2 are the way 1, the way 5, the way 9, and the way 13; ways allocated to a VM 3 are the way 2, the way 6, the way 10, and the way 14; ways allocated to a VM 4 are the way 3, the way 7, the way 11, and the way 15. If the first mode is the VM 3, the available ways of the first mode are the way 2, the way 6, the way 10, and the way 14.

Generally, ways in a cache may be allocated in two manners. One manner is default allocation, which means that all or some ways are allocated to a mode (a network standard or a VM) by default. Ways allocated to all modes by means of default allocation are the same. For example, if ways allocated by default are ways 0 to 15 or a way 0 and a way 1, all ways allocated to each mode by means of default allocation are the ways 0 to 15 or the way 0 and the way 1. The other manner is separate allocation, opposite to default allocation. That is, all or some ways are separately allocated to a mode. Ways allocated to all modes by means of separate allocation may be the same, be completely different, or be partly the same and partly different. In this embodiment, ways are allocated to the first mode by means of separate allocation.

Step 102: Receive a first data access request, where the first data access request includes an identifier of the first mode. Step 102 and step 101 are performed in no particular order.

Step 103: Store a data block, to be accessed by using the first data access request, in the used-for-replacement way of the first mode when the data block to be accessed by using the first data access request is not stored in the cache.

It is easily known that the cache first forwards the first data access request to another cache or a main memory when the data block to be accessed by using the first data access request is not stored in the cache. After a CPU completes access to the data block, to be accessed by using the first data access request, in the another cache or the main memory, the cache stores the data block, accessed by using the first data access request, in a way in the cache according to the requirement in step 103.

In this embodiment of the present invention, an available way is selected at a specified interval from available ways of a first mode as a used-for-replacement way of the first mode, and each available way of the first mode has an equal probability of acting as the used-for-replacement way of the first mode. That is, the used-for-replacement way of the first mode may be any available way of the first mode. A data block to be accessed by using a first data access request is stored in the used-for-replacement way of the first mode when the data block to be accessed by using the first data access request is not stored in a cache. Therefore, each available way of the first mode has an equal probability of storing the data block to be accessed by using the first data access request. That is, each available way of the first mode has an equal probability of being used for implementing replacement of a data block of the first mode.

### Embodiment 2

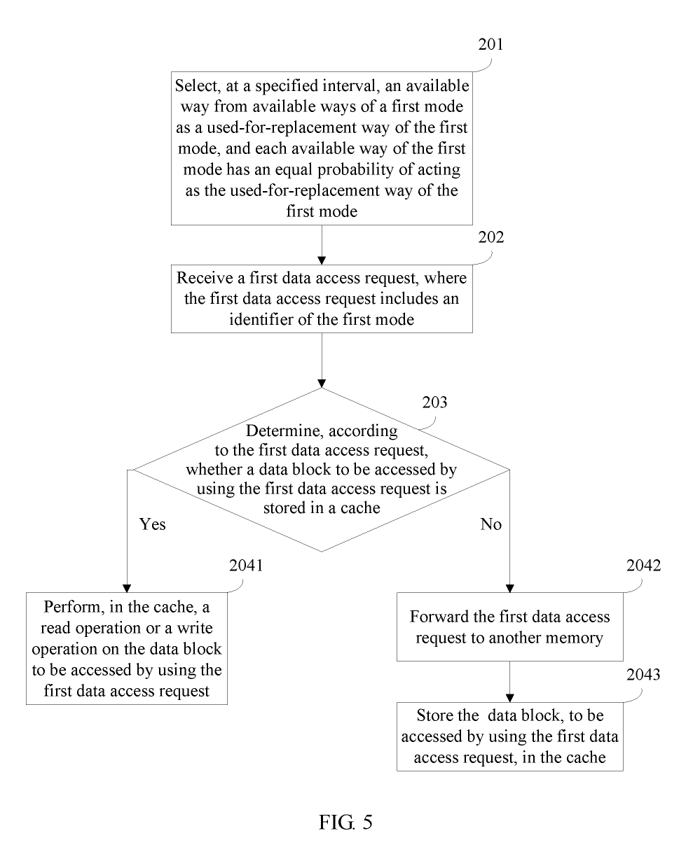

This embodiment of the present invention provides a method for replacing a data block in a cache. Storage space of the cache is divided into several sets. Each set includes several ways, and each set includes an equal quantity of ways. The storage space of the cache is divided and allocated to multiple modes according to ways. All the modes can use same several ways in all the sets. For example, the cache includes sets 0 to 7, each of the sets 0 to 7 includes ways 0 to 15, the ways 0 to 7 are allocated to a mode 1, and the ways 8 to 15 are allocated to a mode 2. In this case, the mode 1 can use the ways 0 to 7 in the sets 0 to 7, and the mode 2 can use the ways 8 to 15 in the sets 0 to 7. That is, several ways are allocated to multiple modes. The modes are network standards or VMs. Referring to FIG. 5, a specific implementation process is as follows.

Step 201: Select, at a specified interval, an available way from available ways of a first mode as a used-for-replacement way of the first mode, and each available way of the first mode has an equal probability of acting as the used-for-replacement way of the first mode. Step 201 may be performed all the time.

In this embodiment, the first mode is one of the multiple modes and may be a network standard or a VM. It should be noted that there may be one or more first modes in the multiple modes to which ways in the cache are allocated. Specifically, network standards include GSM, CDMA, 3G, LTE, and the like. The VM is a computer system that runs in a completely isolated environment, that has complete hardware system functions, and that is simulated by using software on an operating system of a computer.

The available ways of the first mode are ways allocated to the first mode. For example, all ways in the cache are ways 0 to 15. Ways allocated to a network standard 1 (for example, GSM) are the ways 0 to 7, and ways allocated to a network standard 2 (for example, CDMA) are the ways 8 to 15. If the first mode is the network standard 2, the available ways of the first mode are the ways 8 to 15. Alternatively, ways allocated to a VM 1 are the way 0, the way 4, the way 8, and the way 12; ways allocated to a VM 2 are the way 1, the way 5, the way 9, and the way 13; ways allocated to a VM 3 are the way 2, the way 6, the way 10, and the way 14; ways allocated to a VM 4 are the way 3, the way 7, the way 11, and the way 15. If the first mode is the VM 3, the available ways of the first mode are the way 2, the way 6, the way 10, and the way 14.

Generally, ways in a cache may be allocated in two manners. One manner is default allocation, which means that all or some ways are allocated to a mode (a network standard or a VM) by default. Ways allocated to all modes by means of default allocation are the same. For example, if ways allocated by default are ways 0 to 15 or a way 0 and a way 1, all ways allocated to each mode by means of default allocation are the ways 0 to 15 or the way 0 and the way 1. The other manner is separate allocation, opposite to default allocation. That is, all or some ways are separately allocated to a mode. Ways allocated to all modes by means of separate allocation may be the same, be completely different, or be partly the same and partly different. In this embodiment, ways are allocated to the first mode by means of separate allocation.

For all modes (network standards or VMs) to which ways in one cache are allocated, ways can be allocated to all the modes by means of separate allocation; or ways can be allocated to some of the modes by means of separate allocation and ways can be allocated to the other modes by means of default allocation. For example, ways are allocated to no more than a specified quantity (for example, 16) of modes by means of separate allocation, and ways are allocated to the other modes by means of default allocation. Specifically, a mode to which ways are allocated by means of separate allocation may be at least one of a mode that needs to have independent resources or a mode that easily interferes with another mode. It can be understood that separate allocation requires more resources and higher overheads than default allocation does. Therefore, compared with allocating ways to all modes by means of separate allocation, allocating ways to no more than a specified quantity of modes by means of separate allocation can reduce resource usage and overheads.

In an implementation manner of this embodiment, the available way selected for the first mode at the specified interval may change periodically.

For example, if ways allocated to a mode 1 are a way 0, a way 4, a way 8, and a way 12, available ways selected for the mode 1 at a specified interval are sequentially the way 0, the way 4, the way 8, the way 12, the way 0, the way 4, the way 8, the way 12, and so on.

In specific implementation, the foregoing implementation manner may be implemented by using a loop counter. Input to the loop counter is labels (there may be one or more labels) of all available ways of a mode. Output from the loop counter is a label of a used-for-replacement way of the mode. The loop counter outputs a new label at a specified interval, and the new label replaces an old label and is used as the label of the used-for-replacement way of the mode.

In another implementation manner of this embodiment, the available way selected for the first mode at the specified interval may change randomly.

In specific implementation, the foregoing implementation manner may be implemented by using a random number generator. Input to the random number generator is labels of all available ways of a mode. Output from the random number generator is a label of a used-for-replacement way of the mode.

It can be understood that, according to either of the foregoing two implementation manners, each available way of the first mode may have an equal probability of being selected as a used-for-replacement way.

Specifically, step 201 may include:

determining the used-for-replacement way of the first mode by using a masked replace way generator (Masked Replace Way Generator, MRWG for short), where input to the MRWG is a mask that indicates the available ways of the first mode, and output from the MRWG is an indication signal that indicates the used-for-replacement way of the first mode.

For example, available ways of a mode 1 are a way 0, a way 4, a way 8, and a way 12. A mask 0111_0111_0111_0111 is input to an MRWG corresponding to the mode 1. Each bit of the mask indicates whether a way is an available way of the mode 1. 0 indicates yes, and 1 indicates no. For example, the first bit of the mask is 0, indicating that the available ways of the mode 1 include the way 0. The second bit of the mask is 1, indicating that the available ways of the mode 1 do not include a way 1. The MRWG corresponding to the mode 1 receives the input mask, and sequentially outputs 0x0, 0x4, 0x8, 0x12, 0x0, 0x4, 0x8, 0x12, and so on. An output value is a label of a used-for-replacement way.

In an implementation manner of this embodiment, the replacement method may further include:

selecting an available way from available ways of a second mode as a used-for-replacement way of the second mode when an available way is selected from the available ways of the first mode as the used-for-replacement way of the first mode, where each available way of the second mode has an equal probability of acting as the used-for-replacement way of the second mode, the second mode is one of the multiple modes, and the available ways of the second mode are ways allocated to the second mode.

In the foregoing implementation manner, ways are allocated to the second mode by means of separate allocation, the same manner in which ways are allocated to the first mode. A difference between the first mode and the second mode is that the first mode is a mode to be accessed by using a data access request (for details, refer to step 202) while the second mode is not. It should be noted that there may be one or more second modes in the multiple modes to which ways in the cache are allocated.

Similarly, the selecting an available way from available ways of a second mode as a used-for-replacement way of the second mode may include:

determining the used-for-replacement way of the second mode by using an MRWG, where input to the MRWG is a mask that indicates the available ways of the second mode, and output from the MRWG is an indication signal that indicates the used-for-replacement way of the second mode.

That is, multiple MRWGs are disposed in the cache, and a one-to-one correspondence exists between the MRWGs and modes to which ways are allocated by means of separate allocation. Regardless of whether a data access request is received, an MRWG determines a used-for-replacement way of a corresponding mode at a specified interval.

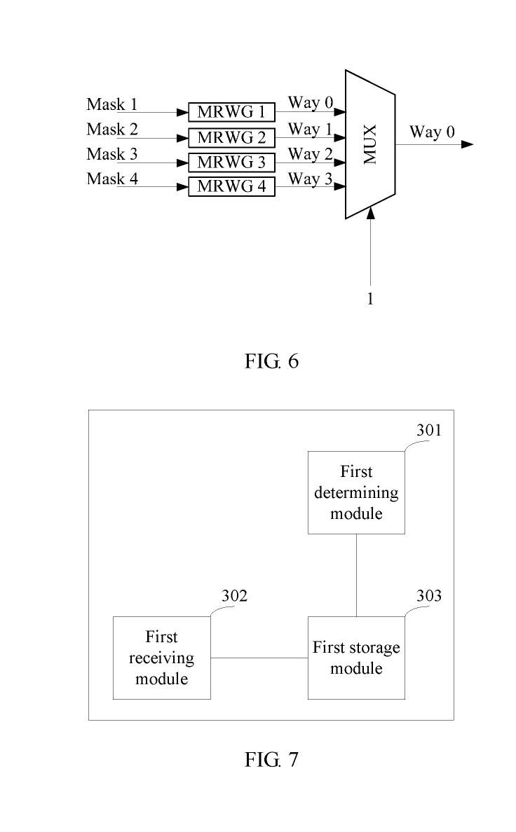

Specifically, input to an MRWG i is a mask i that indicates available ways of a mode j, and output from the MRWG i is an indication signal way jk that indicates a used-for-replacement way of the mode j, where 0≦i≦a quantity (for example, 16) of modes to which ways are allocated by means of separate allocation, i is an integer, the mode j is any one of all modes to which ways are allocated by means of separate allocation, and way jk is any one of the available ways of the mode j. As shown in FIG. 6, input to an MRWG 1 is a mask 1 (0111_0111_0111_0111) that indicates available ways of a mode 1, and output from the MRWG 1 is an indication signal way 0 that indicates a used-for-replacement way of the mode 1. Input to an MRWG 2 is a mask 2 (1011_1011_1011_1011) that indicates available ways of a mode 2, and output from the MRWG 2 is an indication signal way 1 that indicates a used-for-replacement way of the mode 2. Input to an MRWG 3 is a mask 3 (1101_1101_1101_1101) that indicates available ways of a mode 3, and output from the MRWG 3 is an indication signal way 2 that indicates a used-for-replacement way of the mode 3. Input to an MRWG 4 is a mask 4 (1110_1110_1110_1110) that indicates available ways of a mode 4, and output from the MRWG 4 is an indication signal way 3 that indicates a used-for-replacement way of the mode 4. It should be noted that FIG. 6 is used only as an example, and the present invention is not limited thereto.

In a specific application, an MRWG may be a loop counter or a random number generator. It is easily known that each available way has an equal probability of being selected as a used-for-replacement way.

In an actual application, after ways are allocated to each mode, an allocation table is established or updated. The allocation table lists a correspondence between each mode and all ways allocated to the mode (that is, available ways of the mode). Available ways of each mode can be obtained by directly querying the allocation table. Then, a mask that indicates the available ways of the mode is generated, and the mask is input to a corresponding MRWG

Step 202: Receive a first data access request, where the first data access request includes an identifier of the first mode. Step 202 and step 201 are performed in no particular order.

As described in the foregoing application scenario part, an address part in the first data access request includes a tag field, an index field, and an offset field. As described above, the index field is used to index a set. The tag field is used for a comparison with a tag field of each way in the cache, so as to determine whether a data block stored in the way is a to-be-accessed data block. The offset field includes an address, in the data block, of to-be-accessed data.

Step 203: Determine, according to the first data access request, whether a data block to be accessed by using the first data access request is stored in the cache. Step 2041 is performed when the data block to be accessed by using the first data access request is stored in the cache; or step 2042 and step 2043 are performed when the data block to be accessed by using the first data access request is not stored in the cache.

Specifically, step 203 may include:

determining, according to the index field in the address part of the first data access request, a set to which the data block to be accessed by using the first data access request belongs;

comparing the tag field in the address part of the first data access request with a tag field of each way in the determined set; and

if the tag field in the address part of the first data access request is the same as a tag field of a way in the determined set, determining that the data block to be accessed by using the first data access request is stored in the cache; or

if the tag field in the address part of the first data access request is different from tag fields of all ways in the determined set, determining that the data block to be accessed by using the first data access request is not stored in the cache.

Step 2041: Perform, in the cache, a read operation or a write operation on the data block to be accessed by using the first data access request.

Specifically, step 2041 may include:

when the first data access request is data read, sending the data block, to be accessed by using the first data access request, stored in the cache to a CPU; or

when the first data access request is data write, updating the data block, to be accessed by using the first data access request, stored in the cache with the data in the first data access request.

Step 2042: Forward the first data access request to another memory.

Specifically, the first data access request is sent to a lower-level memory. When only one cache is disposed between the CPU and a main memory, the lower-level memory is the main memory. When multiple caches are disposed between the CPU and a main memory, the lower-level memory is a memory (a cache or the main memory) adjacent to the cache and closer to the main memory.

It is easily known that the cache first forwards the first data access request to another cache or the main memory when the data block to be accessed by using the first data access request is not stored in the cache. After the CPU completes access to the data block, to be accessed by using the first data access request, in the another cache or the main memory (that is, after the CPU performs a read operation or a write operation on the data block, to be accessed by using the first data access request, in the another cache or the main memory), the cache stores the data block, accessed by using the first data access request, in a way in the cache (for details, see step 2043).

Step 2043: Store the data block, to be accessed by using the first data access request, in the cache.

In an implementation manner of this embodiment, when all the ways, allocated to the first mode, included in the set to which the data block to be accessed by using the first data access request belongs includes an empty way that stores no data block, step 2043 may include:

storing the data block, to be accessed by using the first data access request, in any empty way of the first mode.

In another implementation manner of this embodiment, when each way, allocated to the first mode, included in the set to which the data block to be accessed by using the first data access request belongs stores a data block, step 2043 may include:

selecting the used-for-replacement way of the first mode from used-for-replacement ways of all the modes according to the identifier of the first mode; and

storing the data block, to be accessed by using the first data access request, in the used-for-replacement way of the first mode.

As described in step 201, the cache includes more than one used-for-replacement way, and includes at least the used-for-replacement way of the first mode and the used-for-replacement way of the second mode. When the first data access request is received, the used-for-replacement way of the first mode needs to be selected from all used-for-replacement ways according to the identifier, included in the first data access request, of the first mode. Then, the data block to be accessed by using the first data access request can be stored in the used-for-replacement way of the first mode.

For example, ways allocated to a mode 1 are ways 0 to 7, ways allocated to a mode 2 are ways 8 to 15, a used-for-replacement way of the mode 1 is the way 0, a used-for-replacement way of the mode 2 is the way 15, and the first mode is the mode 2. In this case, the way 15 is first selected from the way 0 and the way 15, and then the data block to be accessed by using the first data access request is stored in the way 15.

As described in step 201, corresponding MRWGs are disposed for both the first mode and the second mode to determine the used-for-replacement ways of the first mode and the second mode. Therefore, the selecting the used-for-replacement way of the first mode according to the identifier of the first mode may include:

selecting, according to a correspondence between an identifier of a first mode and an identifier of an MRWG, an MRWG corresponding to the first mode;

determining a way indicated by output from the selected MRWG as the used-for-replacement way of the first mode; and

storing the data block, to be accessed by using the first data access request, in the used-for-replacement way of the first mode.

It is easily known that the first mode corresponds to its identifier (that is, the identifier of the first mode), and an MRWG corresponds to its identifier (that is, the identifier of the MRWG); because a one-to-one correspondence exists between MRWGs and modes, a correspondence exists between the identifier of the first mode and an identifier of an MRWG. The identifier of the MRWG can be determined directly according to the correspondence and the identifier, included in the first data access request, of the first mode, so as to select the MRWG corresponding to the first mode.

In specific implementation, a used-for-replacement way can be selected by using a data selector (MUX). Specifically, an identifier, output from each MRWG, of a used-for-replacement way is input to the MUX, and the MUX selects, from all input used-for-replacement ways according to an identifier (for example, a number) of an MRWG, a used-for-replacement way corresponding to the identifier of the MRWG. As shown in FIG. 6, the number is 1, and a label output from an MRWG corresponding to 1 is 0; therefore, a selected used-for-replacement way is a way 0. An identifier of an MRWG may be determined in the following implementation manners.

In an implementation manner, a comparison table may be established. In the table, a correspondence is established between an identifier of each mode and an identifier of an MRWG that is in a one-to-one correspondence with the mode (that is, a correspondence is established between the identifier of the first mode and an identifier of an MRWG). When the identifier, included in the first data access request, of the first mode is obtained, an identifier of a corresponding MRWG is found directly according to the identifier of the first mode, and the identifier of the corresponding MRWG is sent to the MUX. Then, the MUX determines, according to the identifier of the MRWG a way output from the MRWG corresponding to the identifier as the used-for-replacement way of the first mode.

It can be understood that, in the foregoing implementation manner, an identifier of each mode does not need to be completely the same as an identifier of an MRWG. For example, an MRWG corresponding to a mode 1 may be an MRWG 2, and an MRWG corresponding to a mode 2 may be an MRWG 1. It can be understood that, when step 201 needs to be performed, an identifier of each mode is generally different from an identifier of a corresponding MRWG In this case, it is preferable to use the foregoing adaptive implementation manner.

In another implementation manner, an identifier of an MRWG corresponding to each mode may be directly set to be the same as an identifier of the mode. For example, an MRWG corresponding to a mode 1 is an MRWG 1, and an MRWG corresponding to a mode 2 is an MRWG 2. In this implementation manner, the identifier, included in the first data access request, of the first mode can be directly sent to the MUX, and the MUX determines, according to the identifier (equal to an identifier of an MRWG in this implementation manner) of the first mode, a way output from the MRWG as the used-for-replacement way of the first mode.

It can be understood that the foregoing implementation manner is simpler.

In an actual application, a specific implementation process may further include the following steps:

receiving a second data access request, where the second data access request includes an identifier of a third mode, and the third mode is one of the multiple modes;

selecting, according to a preset rule, a way from specified ways as a used-for-replacement way of the third mode when a data block to be accessed by using the second data access request is not stored in the cache; and

storing the data block, to be accessed by using the second data access request, in the used-for-replacement way of the third mode.

In the foregoing implementation manner, a difference between the third mode and the first and the second modes is that ways are allocated to the third mode by means of default allocation. It is easily known that the specified ways are ways allocated to the third mode. It should be noted that there may be one or more third modes in the multiple modes to which ways in the cache are allocated.

In specific implementation, the specified ways may be all or some of the ways in the cache. For example, if the cache includes ways 0 to 15, the specified ways may be all of the ways (the ways 0 to 15), the first two ways (the way 0 and the way 1), or the last two ways (the way 14 and the way 15).

The preset rule may be that, when empty ways exist in the specified ways, a way is randomly selected from the empty ways; or when no empty way exists in the specified ways, a way is randomly selected from the specified ways.

In this embodiment of the present invention, an available way is selected at a specified interval from available ways of a first mode as a used-for-replacement way of the first mode, and each available way of the first mode has an equal probability of acting as the used-for-replacement way of the first mode. That is, the used-for-replacement way of the first mode may be any available way of the first mode. A data block to be accessed by using a first data access request is stored in the used-for-replacement way of the first mode when the data block to be accessed by using the first data access request is not stored in a cache. Therefore, each available way of the first mode has an equal probability of storing the data block to be accessed by using the first data access request. That is, each available way of the first mode has an equal probability of being used for implementing replacement of a data block of the first mode.

### Embodiment 3

Referring to FIG. 7, this embodiment of the present invention provides an apparatus for replacing a data block in a cache. The cache includes several ways, the several ways are allocated to multiple modes, and the modes are network standards or VMs. The replacement apparatus includes:

a first determining module 301, configured to select, at a specified interval, an available way from available ways of a first mode as a used-for-replacement way of the first mode, where each available way of the first mode has an equal probability of acting as the used-for-replacement way of the first mode, the first mode is one of the multiple modes, and the available ways of the first mode are ways allocated to the first mode;

a first receiving module 302, configured to receive a first data access request, where the first data access request includes an identifier of the first mode; and

a first storage module 303, configured to store a data block, to be accessed by using the first data access request, in the used-for-replacement way of the first mode when the data block to be accessed by using the first data access request is not stored in the cache.

In this embodiment, the first mode is one of the multiple modes and may be a network standard or a VM. Specifically, network standards include GSM, CDMA, LTE, and the like. The VM is a computer system that runs in a completely isolated environment, that has complete hardware system functions, and that is simulated by using software on an operating system of a computer.

The available ways of the first mode are ways allocated to the first mode. For example, all ways in the cache are ways 0 to 15. Ways allocated to a network standard 1 (for example, GSM) are the ways 0 to 7, and ways allocated to a network standard 2 (for example, CDMA) are the ways 8 to 15. If the first mode is the network standard 2, the available ways of the first mode are the ways 8 to 15. Alternatively, ways allocated to a VM 1 are the way 0, the way 4, the way 8, and the way 12; ways allocated to a VM 2 are the way 1, the way 5, the way 9, and the way 13; ways allocated to a VM 3 are the way 2, the way 6, the way 10, and the way 14; and ways allocated to a VM 4 are the way 3, the way 7, the way 11, and the way 15. If the first mode is the VM 3, the available ways of the first mode are the way 2, the way 6, the way 10, and the way 14.

Generally, ways in a cache may be allocated in two manners. One manner is default allocation, which means that all or some ways are allocated to a mode (a network standard or a VM) by default. Ways allocated to all modes by means of default allocation are the same. For example, if ways allocated by default are ways 0 to 15 or a way 0 and a way 1, all ways allocated to each mode by means of default allocation are the ways 0 to 15 or the way 0 and the way 1. The other manner is separate allocation, opposite to default allocation. That is, all or some ways are separately allocated to a mode. Ways allocated to all modes by means of separate allocation may be the same, be completely different, or be partly the same and partly different. In this embodiment, ways are allocated to the first mode by means of separate allocation.

It is easily known that the cache first forwards the first data access request to another cache or a main memory when the data block to be accessed by using the first data access request is not stored in the cache. After a CPU completes access to the data block, to be accessed by using the first data access request, in the another cache or the main memory, the cache stores the data block, accessed by using the first data access request, in a way of the cache by using the first storage module 303.

In this embodiment of the present invention, an available way is selected at a specified interval from available ways of a first mode as a used-for-replacement way of the first mode, and each available way of the first mode has an equal probability of acting as the used-for-replacement way of the first mode. That is, the used-for-replacement way of the first mode may be any available way of the first mode. A data block to be accessed by using a first data access request is stored in the used-for-replacement way of the first mode when the data block to be accessed by using the first data access request is not stored in a cache. Therefore, each available way of the first mode has an equal probability of storing the data block to be accessed by using the first data access request. That is, each available way of the first mode has an equal probability of being used for implementing replacement of a data block of the first mode.

### Embodiment 4

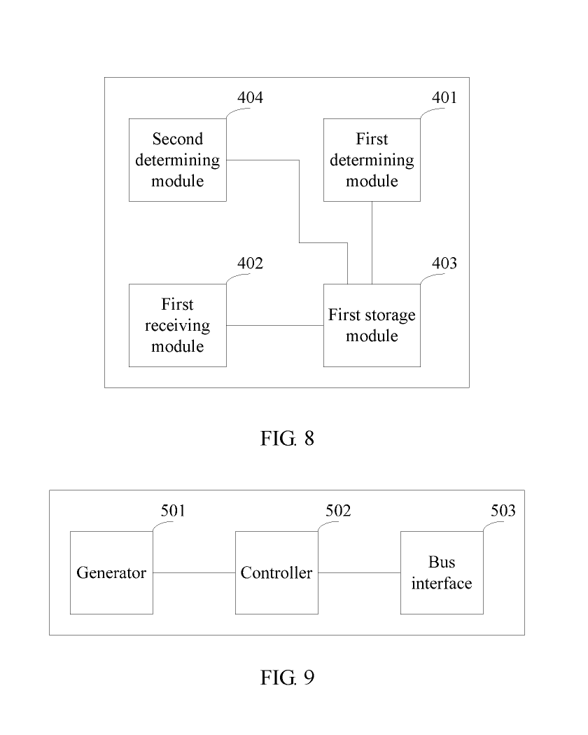

Referring to FIG. 8, this embodiment of the present invention provides an apparatus for replacing a data block in a cache. The cache includes several ways, the several ways are allocated to multiple modes, and the modes are network standards or VMs. The replacement apparatus includes:

a first determining module 401, configured to select, at a specified interval, an available way from available ways of a first mode as a used-for-replacement way of the first mode, where each available way of the first mode has an equal probability of acting as the used-for-replacement way of the first mode, the first mode is one of the multiple modes, and the available ways of the first mode are ways allocated to the first mode;

a first receiving module 402, configured to receive a first data access request, where the first data access request includes an identifier of the first mode; and

a first storage module 403, configured to store a data block, to be accessed by using the first data access request, in the used-for-replacement way of the first mode when the data block to be accessed by using the first data access request is not stored in the cache.

In this embodiment, the first mode is one of the multiple modes and may be a network standard or a VM. Specifically, network standards include GSM, CDMA, LTE, and the like. The VM is a computer system that runs in a completely isolated environment, that has complete hardware system functions, and that is simulated by using software on an operating system of a computer.

The available ways of the first mode are ways allocated to the first mode. For example, all ways in the cache are ways 0 to 15. Ways allocated to a network standard 1 (for example, GSM) are the ways 0 to 7, and ways allocated to a network standard 2 (for example, CDMA) are the ways 8 to 15. If the first mode is the network standard 2, the available ways of the first mode are the ways 8 to 15. Alternatively, ways allocated to a VM 1 are the way 0, the way 4, the way 8, and the way 12; ways allocated to a VM 2 are the way 1, the way 5, the way 9, and the way 13; ways allocated to a VM 3 are the way 2, the way 6, the way 10, and the way 14; and ways allocated to a VM 4 are the way 3, the way 7, the way 11, and the way 15. If the first mode is the VM 3, the available ways of the first mode are the way 2, the way 6, the way 10, and the way 14.

Generally, ways in a cache may be allocated in two manners. One manner is default allocation, which means that all or some ways are allocated to a mode (a network standard or a VM) by default. Ways allocated to all modes by means of default allocation are the same. For example, if ways allocated by default are ways 0 to 15 or a way 0 and a way 1, all ways allocated to each mode by means of default allocation are the ways 0 to 15 or the way 0 and the way 1. The other manner is separate allocation, opposite to default allocation. That is, all or some ways are separately allocated to a mode. Ways allocated to all modes by means of separate allocation may be the same, be completely different, or be partly the same and partly different. In this embodiment, ways are allocated to the first mode by means of separate allocation.

It is easily known that the cache first forwards the first data access request to another cache or a main memory when the data block to be accessed by using the first data access request is not stored in the cache. After a CPU completes access to the data block, to be accessed by using the first data access request, in the another cache or the main memory, the cache stores the data block, accessed by using the first data access request, in a way of the cache by using the first storage module 403.

In an implementation manner of this embodiment, the available way selected at the specified interval may change periodically.

In another implementation manner of this embodiment, the available way selected at the specified interval may change randomly.

It can be understood that, according to either of the foregoing two implementation manners, for each mode in the multiple modes, each available way may have an equal probability of being selected as a used-for-replacement way.

In still another implementation manner of this embodiment, the first determining module 401 may be configured to:

determine the used-for-replacement way of the first mode by using an MRWG, where input to the MRWG is a mask that indicates the available ways of the first mode, and output from the MRWG is an indication signal that indicates the used-for-replacement way of the first mode.

In specific implementation, an MRWG may be a loop counter or a random number generator.

Optionally, the first storage module 403 may include:

a selection unit, configured to select, according to a correspondence between an identifier of a first mode and an identifier of an MRWG, an MRWG corresponding to the first mode;

a determining unit, configured to determine a way indicated by output from the selected MRWG as the used-for-replacement way of the first mode; and

a storage unit, configured to store the data block, to be accessed by using the first data access request, in the used-for-replacement way of the first mode.

In specific implementation, the selection unit may be a MUX.

In yet another implementation manner of this embodiment, the replacement apparatus may further include:

a second determining module 404, configured to select an available way from available ways of a second mode as a used-for-replacement way of the second mode when an available way is selected from the available ways of the first mode as the used-for-replacement way of the first mode, where each available way of the second mode has an equal probability of acting as the used-for-replacement way of the second mode, the second mode is one of the multiple modes, and the available ways of the second mode are ways allocated to the second mode.

Optionally, the second determining module 404 may be configured to:

determine the used-for-replacement way of the second mode by using an MRWG, where input to the MRWG is a mask that indicates the available ways of the second mode, and output from the MRWG is an indication signal that indicates the used-for-replacement way of the second mode.

That is, multiple MRWGs are disposed in the cache, and a one-to-one correspondence exists between the MRWGs and modes to which ways are allocated by means of separate allocation. Regardless of whether a data access request is received, an MRWG determines a used-for-replacement way of a corresponding mode at a specified interval.

In still yet another implementation manner of this embodiment, the replacement apparatus may further include:

a second receiving module, configured to receive a second data access request, where the second data access request includes an identifier of a third mode, and the third mode is one of the multiple modes;

a selection module, configured to select, according to a preset rule, a way from specified ways as a used-for-replacement way of the third mode when a data block to be accessed by using the second data access request is not stored in the cache; and

a second storage module, configured to store the data block, to be accessed by using the second data access request, in the used-for-replacement way of the third mode.

In this embodiment of the present invention, an available way is selected at a specified interval from available ways of a first mode as a used-for-replacement way of the first mode, and each available way of the first mode has an equal probability of acting as the used-for-replacement way of the first mode. That is, the used-for-replacement way of the first mode may be any available way of the first mode. A data block to be accessed by using a first data access request is stored in the used-for-replacement way of the first mode when the data block to be accessed by using the first data access request is not stored in a cache. Therefore, each available way of the first mode has an equal probability of storing the data block to be accessed by using the first data access request. That is, each available way of the first mode has an equal probability of being used for implementing replacement of a data block of the first mode.

### Embodiment 5

Referring to FIG. 9, this embodiment of the present invention provides an apparatus for replacing a data block in a cache. The cache includes several ways, the several ways are allocated to multiple modes, and the modes are network standards or VMs. The replacement apparatus includes a generator 501, a controller 502, and a bus interface 503.

The controller 502 is configured to write to-be-written data included in a data write request into the cache after the bus interface 503 receives the data write request, and is further configured to: read, after the bus interface 503 receives a data read request, to-be-read data from the cache according to an address, included in the data read request, of the to-be-read data, and send the to-be-read data by using the bus interface 503.

Specifically, the generator 501 is configured to select, at a specified interval, an available way from available ways of a first mode as a used-for-replacement way of the first mode, where each available way of the first mode has an equal probability of acting as the used-for-replacement way of the first mode, the first mode is one of the multiple modes, and the available ways of the first mode are ways allocated to the first mode. The controller 502 is configured to: receive a first data access request by using the bus interface 503, where the first data access request includes an identifier of the first mode; and store a data block, to be accessed by using the first data access request, in the used-for-replacement way, determined by the generator 501, of the first mode when the data block to be accessed by using the first data access request is not stored in the cache.

In a possible implementation manner of this embodiment of the present invention, the available way selected at the specified interval may change periodically or randomly.

In another possible implementation manner of this embodiment of the present invention, the generator 501 may include at least one MRWG and each MRWG corresponds to a different mode. An MRWG corresponding to the first mode is configured to determine the used-for-replacement way of the first mode. Input to the MRWG corresponding to the first mode is a mask that indicates the available ways of the first mode. Output from the MRWG corresponding to the first mode is an indication signal that indicates the used-for-replacement way of the first mode.

Optionally, the generator 501 may further include a MUX. The MUX is configured to: select, according to a correspondence between an identifier of a first mode and an identifier of an MRWG, the MRWG corresponding to the first mode; and determine a way indicated by output from the selected MRWG as the used-for-replacement way of the first mode. Correspondingly, the controller 502 is configured to store the data block, to be accessed by using the first data access request, in the used-for-replacement way, determined by the MUX, of the first mode.

In still another possible implementation manner of this embodiment of the present invention, when the MRWG corresponding to the first mode selects an available way from the available ways of the first mode as the used-for-replacement way of the first mode, an MRWG corresponding to a second mode may be configured to select an available way from available ways of the second mode as a used-for-replacement way of the second mode. Each available way of the second mode has an equal probability of acting as the used-for-replacement way of the second mode. The second mode is one of the multiple modes. The available ways of the second mode are ways allocated to the second mode.

In yet another possible implementation manner of this embodiment of the present invention, the controller 502 may be further configured to: receive a second data access request by using the bus interface 503, where the second data access request includes an identifier of a third mode, and the third mode is one of the multiple modes; select, according to a preset rule, a way from specified ways as a used-for-replacement way of the third mode when a data block to be accessed by using the second data access request is not stored in the cache; and store the data block, to be accessed by using the second data access request, in the used-for-replacement way of the third mode.

In this embodiment of the present invention, an available way is selected at a specified interval from available ways of a first mode as a used-for-replacement way of the first mode, and each available way of the first mode has an equal probability of acting as the used-for-replacement way of the first mode. That is, the used-for-replacement way of the first mode may be any available way of the first mode. A data block to be accessed by using a first data access request is stored in the used-for-replacement way of the first mode when the data block to be accessed by using the first data access request is not stored in a cache. Therefore, each available way of the first mode has an equal probability of storing the data block to be accessed by using the first data access request. That is, each available way of the first mode has an equal probability of being used for implementing replacement of a data block of the first mode.

It should be noted that, when the apparatus for replacing a data block in a cache provided by the foregoing embodiments replaces a data block in the cache, division of the foregoing functional modules is used only as an example. In an actual application, the foregoing functions can be allocated to and completed by different functional modules according to a requirement, that is, an internal structure of the apparatus is divided into different functional modules to perform all or some of the foregoing functions. In addition, the apparatus for replacing a data block in a cache and the method for replacing a data block in a cache provided by the foregoing embodiments are based on the same inventive concept. For specific implementation processes, refer to the method embodiments, which are not described herein again.

The sequence numbers of the foregoing embodiments of the present invention are only for illustrative purposes, and are not intended to indicate priorities of the embodiments.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are only exemplary embodiments of the present invention, but are not intended to limit the present invention. Any modification, equivalent replacement, and improvement made without departing from the spirit and principle of the present invention shall fall within the protection scope of the present invention.

What is claimed is:

1. A method for replacing a data block in a cache, wherein the cache comprises several ways, the several ways are allocated to multiple modes, and the modes are network standards or virtual machines (VMs); and the replacement method comprises:
selecting, at a specified interval, an available way from available ways of a first mode as a used-for-replacement way of the first mode, wherein each available way of the first mode has an equal probability of acting as the used-for-replacement way of the first mode, the first mode is one of the multiple modes, and the available ways of the first mode are ways allocated to the first mode;
receiving a first data access request, wherein the first data access request comprises an identifier of the first mode; and
storing a data block, to be accessed by using the first data access request, in the used-for-replacement way of the first mode when the data block to be accessed by using the first data access request is not stored in the cache.

2. The replacement method according to claim 1, wherein the available way selected at the specified interval changes periodically or randomly.

3. The replacement method according to claim 1, wherein the selecting, at a specified interval, an available way from available ways of a first mode as a used-for-replacement way of the first mode comprises:
determining the used-for-replacement way of the first mode by using a masked replace way generator (MRWG), wherein input to the MRWG is a mask that indicates the available ways of the first mode, and output from the MRWG is an indication signal that indicates the used-for-replacement way of the first mode.

4. The replacement method according to claim 3, wherein the storing a data block, to be accessed by using the first data access request, in the used-for-replacement way of the first mode when the data block to be accessed by using the first data access request is not stored in the cache comprises:
selecting, according to a correspondence between an identifier of a first mode and an identifier of an MRWG, an MRWG corresponding to the first mode;
determining a way indicated by output from the selected MRWG as the used-for-replacement way of the first mode; and
storing the data block, to be accessed by using the first data access request, in the used-for-replacement way of the first mode.

5. The replacement method according to claim 1, wherein the replacement method further comprises:
selecting an available way from available ways of a second mode as a used-for-replacement way of the second mode when an available way is selected from the available ways of the first mode as the used-for-replacement way of the first mode, wherein each available way of the second mode has an equal probability of acting as the used-for-replacement way of the second mode, the second mode is one of the multiple modes, and the available ways of the second mode are ways allocated to the second mode.

6. The replacement method according to claim 1, wherein the replacement method further comprises:
receiving a second data access request, wherein the second data access request comprises an identifier of a third mode, and the third mode is one of the multiple modes;
selecting, according to a preset rule, a way from specified ways as a used-for-replacement way of the third mode when a data block to be accessed by using the second data access request is not stored in the cache; and
storing the data block, to be accessed by using the second data access request, in the used-for-replacement way of the third mode.

7. An apparatus for replacing a data block in a cache, wherein the cache comprises several ways, the several ways are allocated to multiple modes, and the modes are network standards or virtual machines VMs; and the replacement apparatus comprises:
a first determining module, configured to select, at a specified interval, an available way from available ways of a first mode as a used-for-replacement way of the first mode, wherein each available way of the first mode has an equal probability of acting as the used-for-replacement way of the first mode, the first mode is one of the multiple modes, and the available ways of the first mode are ways allocated to the first mode;
a first receiving module, configured to receive a first data access request, wherein the first data access request comprises an identifier of the first mode; and
a first storage module, configured to store a data block, to be accessed by using the first data access request, in the used-for-replacement way of the first mode when the data block to be accessed by using the first data access request is not stored in the cache.

8. The replacement apparatus according to claim 7, wherein the available way selected at the specified interval changes periodically or randomly.

9. The replacement apparatus according to claim 7, wherein the first determining module is configured to:
determine the used-for-replacement way of the first mode by using a masked replace way generator (MRWG), wherein input to the MRWG is a mask that indicates the available ways of the first mode, and output from the MRWG is an indication signal that indicates the used-for-replacement way of the first mode.

10. The replacement apparatus according to claim 9, wherein the first storage module comprises:
a selection unit, configured to select, according to a correspondence between an identifier of a first mode and an identifier of an MRWG, an MRWG corresponding to the first mode;
a determining unit, configured to determine a way indicated by output from the selected MRWG as the used-for-replacement way of the first mode; and
a storage unit, configured to store the data block, to be accessed by using the first data access request, in the used-for-replacement way of the first mode.

11. The replacement apparatus according to claim 7, wherein the replacement apparatus further comprises:
a second determining module, configured to select an available way from available ways of a second mode as a used-for-replacement way of the second mode when an available way is selected from the available ways of the first mode as the used-for-replacement way of the first mode, wherein each available way of the second mode has an equal probability of acting as the used-for-replacement way of the second mode, the second mode is one of the multiple modes, and the available ways of the second mode are ways allocated to the second mode.

12. The replacement apparatus according to claim 7, wherein the replacement apparatus further comprises:
a second receiving module, configured to receive a second data access request, wherein the second data access request comprises an identifier of a third mode, and the third mode is one of the multiple modes;
a selection module, configured to select, according to a preset rule, a way from specified ways as a used-for-replacement way of the third mode when a data block to be accessed by using the second data access request is not stored in the cache; and
a second storage module, configured to store the data block, to be accessed by using the second data access request, in the used-for-replacement way of the third mode.
